(19) United States
(12) Patent Application Publication
(10) Pub. No.: US 2024/0222664 A1
(43) Pub. Date: Jul. 4, 2024

(54) FUEL CELL FLUSHING SYSTEM AND METHOD THEREFOR

(71) Applicant: HYUNDAI MOBIS CO., LTD., Seoul (KR)

(72) Inventor: Yong Hee LEE, Yongin-si (KR)

(73) Assignee: HYUNDAI MOBIS CO., LTD., Seoul (KR)

(21) Appl. No.: 18/516,289

(22) Filed: Nov. 21, 2023

(30) Foreign Application Priority Data
Jan. 4, 2023 (KR) 10-2023-0001231

(51) Int. Cl. H01M 8/04223; H01M 8/04082; H01M 8/04225; H01M 8/04302; H01M 8/04537; H01M 8/04664; H01M 8/04746

(52) U.S. Cl. CPC H01M 8/04231; H01M 8/04201; H01M 8/04225; H01M 8/04302; H01M 8/04552; H01M 8/04671; H01M 8/04753

(57) ABSTRACT

A fuel cell system and method are provided. The fuel cell system includes a fuel cell stack, parts including a hydrogen supply line for supplying hydrogen to the fuel cell stack, and a controller to control operations of the parts to change a flow velocity of hydrogen in the hydrogen supply line.

### CROSS-REFERENCE TO RELATED APPLICATION

This application claims the benefit of priority to Korean Patent Application No. 10-2023-0001231, filed in the Korean Intellectual Property Office on Jan. 4, 2023, the entire contents of which are incorporated herein by reference.

### BACKGROUND

### 1. Field

The present disclosure relates to a fuel cell system and a fuel cell method, and more particularly, to a fuel cell flushing system and a fuel cell flushing method.

### 2. Description of Related Art

A fuel cell system may produce electrical energy by using a fuel cell stack. For example, when hydrogen is used as a fuel of the fuel cell stack, it may be a measure for solving an environment problem of the earth, and thus fuel cell systems have been continuously researched and developed.

The fuel cell system may include a fuel cell stack that produces electric energy, a fuel supply device that supplies a fuel (hydrogen) to the fuel cell stack, an air supply device that supplies oxygen in air, which is an oxidizer that is necessary for an electrochemical reaction, to the fuel cell stack, and a thermal management system (TMS) that removes heat of reaction of the fuel cell stack to an outside, controls an operation temperature of the fuel cell stack, and performs a water managing function.

In the fuel cell system, the fuel cell stack produces electricity by bringing hydrogen that is a fuel and oxygen in air into a reaction with each other, and discharges heat and water as by-products. According to the fuel cell system, as crossover occurs due to a difference between concentrations of gases in a hydrogen electrode and an air electrode in a fuel cell stack, a hydrogen gas in the hydrogen is diffused to the air electrode whereby a concentration of the hydrogen in the hydrogen electrode decreases, and thus, a cell voltage of the fuel cell stack decreases. To achieve this, according to the fuel cell system, a concentration of hydrogen in the hydrogen electrode is maintained by discharging residual hydrogen through purge of hydrogen.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In a general aspect of the disclosure, a fuel cell system includes a fuel cell stack, a plurality of parts including a hydrogen supply line for supplying hydrogen to the fuel cell stack, and a controller configured to control operations of the plurality of parts to change a flow velocity of hydrogen in the hydrogen supply line.

The plurality of parts may further include a fuel supply valve configured to control supply of the hydrogen to the fuel cell stack, and a fuel-line purge valve configured to discharge gas in a hydrogen electrode of the fuel cell stack.

The controller may be further configured to: perform a first operation of opening the fuel supply valve in a state, in which the fuel-line purge valve is cut off, to adjust a pressure of the hydrogen on the hydrogen supply line to a threshold pressure or more; and perform a second operation of controlling the fuel supply valve and the fuel-line purge valve such that the flow velocity of the hydrogen on the hydrogen supply line is changed.

The controller may be further configured to: perform, (i) as the first operation, an operation of opening the fuel supply valve such that an opening degree of the fuel supply valve becomes a first opening degree in a state, in which the fuel-line purge valve is cut off; perform, (ii) as the second operation, (ii-1) an operation of opening the fuel supply valve such that the opening degree of the fuel supply valve becomes a second opening degree that is less than the first opening degree in a state, in which the fuel-line purge valve is opened, and then, opening the fuel supply valve such that the opening degree of the fuel supply valve becomes a third opening degree that is more than the second opening degree, (ii-2) an operation of opening the fuel supply valve such that the opening degree of the fuel supply valve becomes a fourth opening degree that is more than the second opening degree in a state, in which the fuel-line purge valve is cut off; and perform (ii-3) an operation of opening the fuel supply valve such that the opening degree of the fuel supply valve becomes a fifth opening degree that is more than the second opening degree in a state, in which the fuel-line purge valve is opened.

The controller may be further configured to: perform (ii-3) an operation of opening the fuel supply valve such that the opening degree of the fuel supply valve becomes the fifth opening degree that is more than the second opening degree in a state, in which the fuel-line purge valve is opened; and perform a control such that the opening degree of the fuel supply valve is maintained at the fifth opening degree for a preset time period.

The controller may be further configured to perform the second operation such that an absolute value of a change per unit time of the pressure of the hydrogen on the hydrogen supply line satisfies a condition of less than a first threshold value.

The plurality of parts may include an air compressor configured to supply air to the fuel cell stack.

The controller may be further configured to: perform a first operation of adjusting a pressure of the hydrogen on the hydrogen supply line to a threshold pressure or more by opening the fuel supply valve in a state, in which the fuel-line purge valve is cut off; perform a second operation of controlling the fuel supply valve and the fuel-line purge valve such that the flow velocity of the hydrogen on the hydrogen supply line is changed; and perform a third operation of controlling the air compressor such that the air is supplied to the fuel cell stack.

The controller may be further configured to: control operations of the plurality of parts such that the flow velocity of the hydrogen on the hydrogen supply line is changed before starting the fuel cell; and determine, in a process of starting the fuel cell, whether the fuel cell is abnormal with reference to the at least some of first to n-th unit cell voltages and a reference cell voltage determined with reference to at least some of the first to n-th unit cell voltages corresponding to first to n-th unit cells of the fuel cell stack, respectively.

The controller may be further configured to determine that the fuel cell is abnormal when a specific unit cell corresponding to, among the first to n-th unit cell voltages, a specific unit cell voltage, of which an absolute value of a difference from the reference cell voltage is a second threshold value or more, is present.

The controller may be further configured to stop starting the fuel cell when it is determined that the fuel cell is in an abnormal state.

In another general aspect of the disclosure, a method of flushing a fuel cell system includes: opening a fuel supply valve configured to control supply of hydrogen to a fuel cell stack in a state, in which a fuel-line purge valve configured to discharge gas in a hydrogen electrode of the fuel cell stack is cut off, to adjust a pressure of hydrogen in a hydrogen supply line in which the hydrogen supplied to the fuel cell stack flows, to a threshold pressure or more; and controlling the fuel supply valve and the fuel-line purge valve to change a flow velocity of the hydrogen on the hydrogen supply line.

The opening of the fuel supply valve in the state, in which the fuel-line purge valve is cut off, may include opening the fuel supply valve such that an opening degree of the fuel supply valve becomes a first opening degree in a state, in which the fuel-line purge valve is cut off.

The controlling of the fuel supply valve and the fuel-line purge valve such that the flow velocity of the hydrogen on the hydrogen supply line is changed may include: opening the fuel supply valve such that the opening degree of the fuel supply valve becomes a second opening degree that is less than the first opening degree in a state, in which the fuel-line purge valve is opened, and then, opening the fuel supply valve such that the opening degree of the fuel supply valve becomes a third opening degree that is more than the second opening degree; opening the fuel supply valve such that the opening degree of the fuel supply valve becomes a fourth opening degree that is more than the second opening degree in a state, in which the fuel-line purge valve is cut off; and opening the fuel supply valve such that the opening degree of the fuel supply valve becomes a fifth opening degree that is more than the second opening degree in a state, in which the fuel-line purge valve is opened.

The opening of the fuel supply valve such that the opening degree of the fuel supply valve becomes the fifth opening degree that is more than the second opening degree in a state, in which the fuel-line purge valve is opened may include: performing a control such that the opening degree of the fuel supply valve is maintained at the fifth opening degree for a preset time period.

The controlling of the fuel supply valve and the fuel-line purge valve such that the flow velocity of the hydrogen on the hydrogen supply line is changed may include controlling the fuel supply valve and the fuel-line purge valve such that an absolute value of a change per unit time of the pressure of the hydrogen on the hydrogen supply line satisfies a condition of less than a first threshold value.

The method may further include supplying air to the fuel cell stack by controlling an air compressor configured to supply the air to the fuel cell stack.

The method may further include determining a reference cell voltage determined with reference to at least some of first to n-th unit cell voltages corresponding to first to n-th unit cells of the fuel cell stack, respectively; and determining whether the fuel cell is abnormal with reference to the at least some of the first to n-th unit cell voltages, in a process of starting the fuel cell.

The determining of whether the fuel cell is abnormal may include determining that the fuel cell is abnormal when a specific unit cell corresponding to, among the first to n-th unit cell voltages, a specific unit cell voltage, of which an absolute value of a difference from the reference cell voltage is a second threshold value or more, is present.

The method may further include stopping starting of the fuel cell system when it is determined that the fuel cell is abnormal.

The controller may be further configured to control flushing of the fuel cell stack by gradually increasing pressure in the hydrogen supply line to not exceed preset increments in pressure, to prevent a rapid increase in pressure, or gradually decreasing pressure in the hydrogen supply line to not fall below preset decrements in pressure, to prevent a rapid decrease in pressure.

The controller may be further configured to communicate with the plurality of parts by wire or wirelessly.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a fuel cell system;

FIG. 2 is a block diagram of a fuel cell flushing system according to an embodiment disclosed in the present disclosure;

FIG. 3 is a flowchart illustrating a fuel cell flushing method according to an embodiment disclosed in the present disclosure;

FIG. 4 is a graph schematically illustrating a result of performance of a fuel cell flushing method according to an embodiment disclosed in the present disclosure;

FIG. 5 is a view schematically illustrating a state, in which a flow velocity of hydrogen in a hydrogen supply line is changed as a fuel cell flushing method according to an embodiment disclosed in the present disclosure is performed; and

FIG. 6 is a flowchart of a vehicle driving method using a fuel cell flushing system according to an embodiment disclosed in the present disclosure.

In relation to a description of the drawings, the same or similar components may be denoted by the same or similar reference numerals.

### DETAILED DESCRIPTION

Hereinafter, various embodiments of the present disclosure will be described with reference to the accompanying drawings. Accordingly, those of ordinary skill in the art will recognize that modifications, equivalents, and/or alternatives on the various embodiments described herein can be variously made without departing from the scope and spirit of the present disclosure.

In the present disclosure, it is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “1st” and “2nd” or “first” and “second” may be used to simply distinguish a corresponding component from another, and does not limit the components in other aspects (e.g., an importance or an order). When it is mentioned that a certain (e.g., a first) component is “coupled to” or “connected to” another (e.g., a second) component together with or without a term of “functionally” or “communicatively”, it means that the former component may be connected to the latter component through a third component, directly (e.g., by wire) or wirelessly.

The components (e.g., modules or programs) described in the present disclosure may include a singular or a plurality of entities. According to various embodiments, among the components, one or more components or operations may be omitted or one or more other components or operations may be added. Alternatively or additionally, the plurality of components (e.g., modules or programs) may be integrated into one component. In this case, the integrated components may perform one or more functions of the plurality of components in a way that is the same as or similar to that performed by the corresponding ones of the plurality of components before the integration. According to various embodiments, the operations performed by modules, programs, or other components may be executed sequentially, in parallel, repeatedly, or heuristically, one or more operations may be executed in another sequence or omitted, or one or more other operations may be added.

The term “module” or “part” used in the present disclosure may include a unit configured in a hardware, software, or firmware way, and for example, may be used interchangeably with the terms such as logic, a logic block, a component, or a circuit. The module may be an integral part, or a minimum unit or a portion which performs one or more functions. For example, according to an embodiment, the module may be implemented in a form of an application-specific integrated circuit (ASIC).

Various embodiments of the present disclosure may be implemented by software (e.g., a program or an application) including one or more instructions stored in a storage medium (e.g., a memory) that may be read by a machine. For example, a processor of a device may call, among one or more instructions stored in a storage medium, at least one instruction, and may execute the instruction. This allows at least one function to be performed according to the called at least one instruction. The one or more instructions may include a code that is made by a compiler or a code that may be executed by an interpreter. The storage medium that may be read by a device may be provided in a form of a non-transitory storage medium. Here, the ‘non-transitory storage medium’ means that the storage medium is a tangible device and does not include a signal (e.g., an electromagnetic wave), and with regard to the term, a case, in which data are semi-permanently stored in the storage medium, and a case, in which data are temporarily stored in the storage medium, are not distinguished.

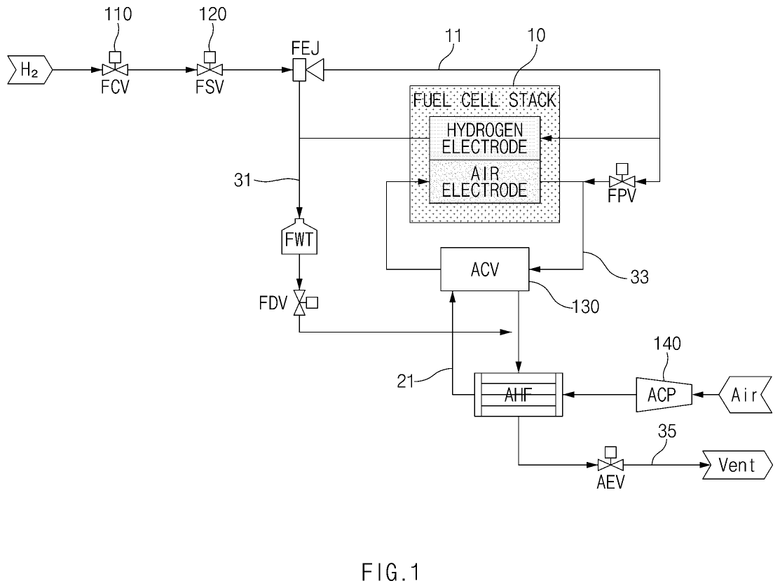

FIG. 1 is a view for helping understanding of a fuel cell flushing system according to an embodiment disclosed in the present disclosure, and schematically illustrates a fuel cell system.

Referring to FIG. 1, a fuel cell system may include a fuel cell stack 10, and may further include a hydrogen supply line 11 that is connected to a hydrogen electrode of the fuel cell stack 10 such that hydrogen supplied to the fuel cell stack 10 flows therethrough, an air supply line 21 that is connected to an air electrode of the fuel cell stack 10 such that air supplied to the fuel cell stack 10 flows therethough, discharge lines 31, 33, and 35 for discharging moisture (water) and non-reaction gases that are reaction by-products, and a hydrogen pressure sensor (not illustrated) for measuring a pressure of the hydrogen in the hydrogen supply line 11.

The fuel cell stack 10 (or may referenced as a ‘fuel cell’) may have a structure that may produce electricity through an oxidation/reduction reaction of a fuel (for example, hydrogen) and an oxidizer (for example, air).

As an example, the fuel cell stack 10 may include a membrane electrode assembly (MEA), in which catalyst electrode layers, in which an electrochemical reaction occurs, are attached on opposite sides of an electrolyte membrane, through which hydrogen ions travel, a gas diffusion layer (GDL) that functions to uniformly distribute reaction gases and deliver generated electrical energy, a gasket and a coupling tool for maintaining a sealing performance and a proper coupling pressure for the reaction gases and a cooling water, and a bipolar plate, through which the reaction gases and the cooling fluid flow.

In the fuel cell stack 10, hydrogen that is a fuel and air (oxygen) that is an oxidizer may be supplied to an anode and a cathode of the membrane electrode assembly through passages of the bipolar plate, and for example, hydrogen may be supplied to the anode that is a hydrogen electrode and the air may be supplied to a cathode that is an air electrode.

The hydrogen supplied to the anode is decomposed to protons and electrons by catalysts of the electrode layers on opposite sides of an electrolyte membrane, and among them, only the hydrogen ions may be delivered to the cathode after selectively passing through the electrolyte membrane that is a positive ion exchange membrane, and the electrons may be delivered to the cathode through the gas diffusion layers and the bipolar plate that are conductors. In the cathode, the hydrogen ions supplied through the electrolyte membrane and the electrons delivered through the bipolar plate may generate a reaction of producing water while meeting oxygen in the air supplied to the cathode by an air supply apparatus. Due to flows of the hydrogen ions, which occur then, the electrons flow through an external wire, and currents may be generated due to the flows of the electrons.

A fuel cut-off valve FCV, a fuel supply valve FSV, a fuel ejector FEJ, and the like may be disposed in the hydrogen supply line 11 that is connected to the hydrogen electrode of the fuel cell stack 10 and in which the hydrogen supplied to the fuel cell stack 10 flows. Furthermore, for example, the hydrogen supply line 11 may be connected to the hydrogen tank.

The fuel cut-off valve FCV 110 may be disposed between the hydrogen tank and the fuel supply valve FSV 120 in the hydrogen supply line 11, and may function to cut off supply of hydrogen discharged from the hydrogen tank to the fuel cell stack 10.

The fuel supply valve FSV 120 may be disposed between the fuel cut-off valve 110 and the fuel ejector FEJ in the hydrogen supply line 11, and may function to adjust a pressure of the hydrogen supplied to the fuel cell stack 10. As an example, the fuel supply valve FSV 120 may be controlled to be opened to supply hydrogen when a pressure of the hydrogen supply line 11 decreases and to be closed when the pressure of the hydrogen supply line 11 increases.

The fuel ejector FEJ may be disposed between the fuel supply valve FSV 120 and the fuel cell stack 10 in the hydrogen supply line 11, and may function to supply the hydrogen to the fuel cell stack 10 by applying a pressure to the hydrogen that passed through the fuel supply valve FSV 120.

The hydrogen supply line 11 may connect an outlet of the fuel cell stack 10 and the fuel ejector FEJ to form a circulation route of hydrogen. Accordingly, the hydrogen discharged by the fuel ejector FEJ may produce electric energy by reacting air in the fuel cell stack 10, and the hydrogen that failed to react may be discharged through the outlet of the fuel cell stack 10 to be reintroduced into the fuel ejector FEJ. In this case, the hydrogen that failed to react may be reintroduced into the fuel ejector FEJ to be supplied to the fuel cell stack 10 again whereby a reaction efficiency of the hydrogen may be enhanced.

Moisture that is present in the hydrogen supply line 11 may be condensed in a process of recirculation of the hydrogen that failed to react in the hydrogen electrode of the fuel cell stack 10. Then, the condensate may be discharged through the first discharge line 31 that connects one point on the hydrogen supply line 11, in which the hydrogen that failed to react in the hydrogen electrode of the fuel cell stack 10 flows to the fuel ejector FEJ and an air humidifier (AHF).

A fuel water trap FWT 100 and a fuel drain valve FDV may be disposed on the first discharge line 31.

The fuel water trap FWT 100 may function to store the condensate introduced from one point of the hydrogen supply line 11 to the first discharge line 31.

The fuel drain valve FDV may function to discharge the condensate stored in the fuel water trap FWT to the air humidifier AHF along the first discharge line 31. Here, the fuel drain valve FDV may be controlled to be in a closed state before a water level of the condensate stored in the fuel water trap 100 exceeds a specific water level and to be opened when the water level of the condensate stored in the fuel water trap FWT exceeds the specific water level such that the condensate is discharged along the first discharge line 31.

An air compressor ACP, the air humidifier AHF, an air cut-off valve ACV, and the like may be disposed in the air supply line 21.

The air compressor ACP may be disposed on the air supply line 21 between an air suction hole, through which ambient air is suctioned, and the air humidifier AHF, and may function to suction and compress the ambient air and supply the compressed air.

The air humidifier AHF may be disposed between the air compressor ACP 140 and the air cut-off valve ACV 130 in the air supply line 21, and may function to adjust a humidity of the air suctioned and compressed by the air compressor ACP 140 and supply the air to the air electrode of the fuel cell stack 10. When the air compressed by the air compressor ACP is introduced through an inlet of the air humidifier, the air humidifier AHF may adjust the humidity by supplying moisture to the introduced air. As an example, the air humidifier AHF may humidify the air supplied from the air compressor ACP 140 by using the condensate introduced through the first discharge line 31 or the moisture included in an air discharged through the second discharge line 33 that connects the air electrode of the fuel cell stack 10 and the air humidifier AHF.

The air humidifier AHF may be connected to the first discharge line 31. Accordingly, the air humidifier AHF may supply moisture to the air supplied from the air compressor ACP 140 by using the condensate introduced through the first discharge line 31.

Furthermore, the air humidifier AHF may be connected to an air discharge hole of the fuel cell stack 10 through the second discharge line 33, and the air discharged from the air electrode of the fuel cell stack 10 may be introduced into the air humidifier AHF through the second discharge line 33. Here, because the air discharged from the air electrode of the fuel cell stack 10 contains moisture, the air humidifier AHF may perform humidification through exchange of moisture between the air discharged from the air electrode of the fuel cell stack 10 and the air supplied from the air compressor ACP 140. In this way, the air, to which the moisture has been supplied by the air humidifier AHF, may be introduced into the air electrode of the fuel cell stack 10 and may produce water as a reactant after reacting with the hydrogen.

Meanwhile, the air humidifier AHF may be connected to an external discharge hole through the third discharge line 35, and may discharge the air introduced through the second discharge line 33 to an outside through the third discharge line 35. Then, an air exhaust valve AEV may be disposed in the third discharge line 35.

The air cut-off valve ACV 130 may be disposed on the air supply line 21 that connects the fuel cell stack 10 and the air humidifier AHF, and may cut off supply the hydrogen discharged from the air humidifier AHF to the air electrode of the fuel cell stack 10 or may adjust a pressure of the air supplied to the air electrode of the fuel cell stack 10. As an example, the air cut-off valve ACV 130 may be controlled to be opened in a start-on state of the fuel cell system and be closed in a start-off state.

Furthermore, the air cut-off valve ACV 130 may be connected to the second discharge line 33 that connects the fuel cell stack 10 and the air humidifier AHF. The air cut-off valve ACV 130 may cut off supply the air discharged from the air electrode of the fuel cell stack 10 to the air humidifier AHF through the second discharge line 33 or may adjust a pressure of the air supplied from the air electrode of the fuel cell stack 10 to the air humidifier AHF.

FIG. 1 illustrates that the air cut-off valve ACV 130 is integrated with and disposed in the air supply line 21 and the second discharge line 33, a first air cut-off valve (not illustrated) disposed on the air supply line 21 and a second air cut-off valve (not illustrated) disposed on the second discharge line 33 may be implemented in a separated form.

Meanwhile, a purge line may be connected to one point on the hydrogen supply line 11, in which the hydrogen supplied from the fuel ejector FEJ flows to the hydrogen electrode of the fuel cell stack 10, and a fuel-line purge valve FPV may be disposed on the purge line.

The fuel-line purge valve FPV is a valve that is opened and closed to manage concentrations of hydrogen in the fuel cell stack 10 and the hydrogen supply line 11, and may function to maintain the concentration of the hydrogen in the fuel cell stack 10 and the hydrogen supply line 11 in specific ranges.

The fuel cell stack 10 may produce electric energy by using hydrogen and air, and the fuel-line purge valve FPV is in a closed state while the fuel cell stack 10 is operated in a normal state.

Here, the air supplied to the fuel cell stack 10 contains nitrogen in addition to oxygen, and voltages of cells may decrease as crossover occurs due to a difference of partial pressures of the nitrogen in the hydrogen electrode and the air electrode. Accordingly, the fuel-line purge valve FPV may discharge residual hydrogen to increase a concentration of the hydrogen in the hydrogen electrode whereby a performance of the stack may be maintained by decreasing a concentration of the nitrogen.

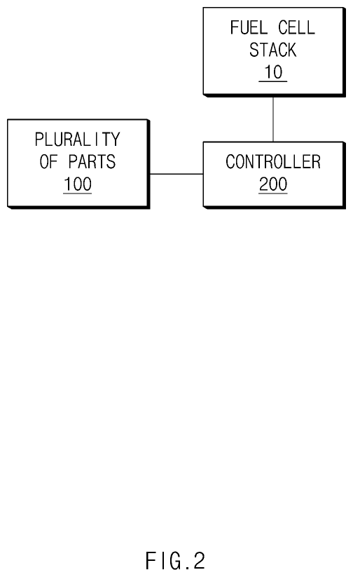

FIG. 2 is a block diagram of the fuel cell flushing system according to an embodiment disclosed in the present disclosure.

Referring to FIG. 2, the fuel cell flushing system may include a plurality of parts 100 and a controller 200 (e.g., a processor).

As an example, the plurality of parts 100 may include various parts, such as electric parts or mechanical parts, which are part of a fuel cell system (i.e., the fuel cell flushing system). For example, the plurality of parts 100 may include at least some of various parts, such as parts, such as the fuel supply valve 120, the fuel-line purge valve FPV, and the air compressor 140 that supplies air to the fuel cell stack 10, which are related to an operation of the fuel cell, and parts, such as a low-voltage battery and a high-voltage battery, which supplies electric power to the fuel cell.

According to an embodiment, the controller 200 may be a hardware device, such as a processor, a micro-processor unit (MPU), a micro controller unit (MCU), a central processing unit (CPU), or an electronic controller unit (ECU), or a program that is implemented by a processor. The controller 200 may be connected to various components of the fuel cell flushing system to perform an overall function for performing flushing of the fuel cell.

The controller 200 may communicate with the plurality of parts 100, the fuel cell stack 10, and the like by wire or wirelessly, and as an example, may perform communication based on CAN communication.

According to an embodiment, the controller 200 may control operations of the plurality of parts 100. Here, controlling the operations of the plurality of parts 100 may include controlling operation states of the plurality of parts 100 or controlling a series of operation sequences of the plurality of parts 100. For example, the controller 200 may control an opening degree of the fuel supply valve 120 included in the plurality of parts 100, or may control the operation sequences of the fuel supply valve 120, the fuel-line purge valve FPV, and the air compressor 140. The controller 200 may change a flow velocity of the hydrogen on the hydrogen supply line 11, in which the hydrogen supplied to the fuel cell stack 10 flows, by controlling the operation states and the operation sequences of the plurality of parts 100.

According to an embodiment, the plurality of parts 100 may include the fuel supply valve 120 and the fuel-line purge valve FPV, and may further include the air compressor 140.

The fuel supply valve 120 may control supply (an amount of supply) of the hydrogen to the fuel cell stack. For example, the fuel supply valve 120 may control an amount of the hydrogen that is injected into the fuel cell stack 10 according to the opening degree. The opening degree may have a value of 0% to 100%, and a larger amount of hydrogen may be supplied as the opening degree becomes higher. Then, the controller 200 may control the amount of the hydrogen supplied to the fuel cell stack 10 by controlling the opening degree of the fuel supply valve 120.

Furthermore, the fuel-line purge valve FPV is a valve that is opened or closed to manage a concentration of hydrogen in the fuel cell stack 10, the hydrogen supply line 11, and the like, and may function to maintain the concentrations of the hydrogen in the fuel cell stack 10 and the hydrogen supply line 11 in specific ranges by discharging the gas in the hydrogen electrode of the fuel cell stack 10.

Furthermore, the air compressor 140 may control a pressure of the air that is supplied to the fuel cell stack 10. Then, controlling the pressure of the air supplied to the fuel cell stack 10 by the air compressor 140 may include controlling a pressure of the air cut-off valve 130 connected to the fuel cell stack 10. The air compressor 140 may form an air pressure at a front end of the air cut-off valve 130 by pushing out the air through rotation of a pump, and the air may be supplied to the fuel cell stack 10 when the air cut-off valve 130 is opened. The controller 200 may control the air pressure by controlling an rpm of the air compressor 140.

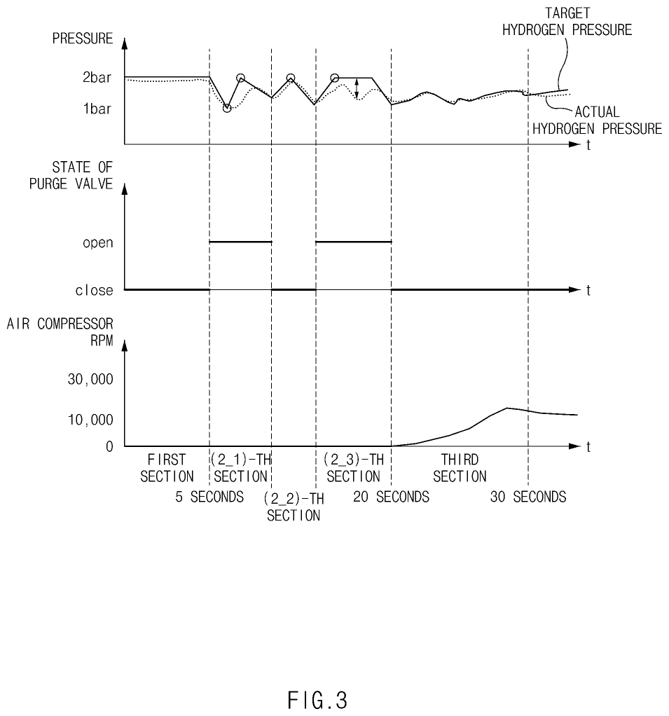

FIG. 3 is a flowchart illustrating a fuel cell flushing method according to an embodiment disclosed in the present disclosure.

Referring to FIG. 3, the controller 200 may perform a first operation of opening the fuel supply valve 120 in a state, in which the fuel-line purge valve FPV is cut off, to adjust a pressure of the hydrogen on the hydrogen supply line 11 to a threshold pressure or more, and perform a second operation of controlling the fuel supply valve 120 and the fuel-line purge valve FPV such that a flow velocity of the hydrogen on the hydrogen supply line 11 is changed.

For reference, when the fuel-line purge valve FPV is cut off, an actual pressure of the hydrogen, which is sensed in the hydrogen supply line 11, follows a target hydrogen pressure corresponding to the opening degree of the fuel supply valve 120 well. For example, when the target hydrogen pressure is set to 2 bar to control the opening degree of the fuel supply valve 120 when the fuel-line purge valve FPV is cut off, the actual pressure of the hydrogen in the hydrogen supply line 11 promptly follows 2 bar.

Meanwhile, when the fuel-line purge valve FPV is opened, the actual pressure of the hydrogen fails to follow the target hydrogen pressure well, and a delay and a lack of the pressure occur. For example, when the fuel-line purge valve FPV is opened, the actual pressure of the hydrogen in the hydrogen supply line follows 2 bar rather slowly even when the opening degree of the fuel supply valve is controlled by setting the target hydrogen pressure to 2 bar, and a maximum pressure value that may be shown by the actual hydrogen pressure is less than 2 bar. According to the embodiments disclosed in the present disclosure, the fuel cell may be flushed by using the above-described characteristics.

For example, the controller 200 may perform, as the first operation, an operation of adjusting the pressure of the hydrogen in the hydrogen supply line 11 to a maximum pressure (for example, 2 bar) by opening the fuel supply valve 120 in a state, in which the fuel-line purge valve FPV is cut off. Furthermore, the controller 200 may perform, as the second operation, an operation of performing a control such that the fuel supply valve 120 and the fuel-line purge valve FPV are opened and closed whereby the flow velocity of the hydrogen on the hydrogen supply line 11 is changed.

According to an embodiment, the first operation and the second operation may be performed for specific time periods. For example, after the first operation (for example, an operation for adjusting the pressure of the hydrogen on the hydrogen supply line 11 to a maximum value) is performed for 5 seconds, the second operation (for example, an operation of controlling opening/closing of the fuel supply valve 120 and the fuel-line purge valve FPV such that the flow velocity of the hydrogen on the hydrogen supply line 11 is changed) may be performed for 15 seconds.

According to an embodiment, the controller 200 may perform, as the first operation, an operation of opening the fuel supply valve 120 such that the opening degree of the fuel supply valve 120 becomes a first opening degree in a state, in which the fuel-line purge valve FPV is cut off. Furthermore, the controller 200 may perform, as the second operation, (i) an operation of opening the fuel supply valve 120 such that an opening degree of the fuel supply valve 120 becomes a first opening degree in a state, in which the fuel-line purge valve FPV is cut off, may perform, (ii) as the second operation, (ii-1) an operation of opening the fuel supply valve 120 such that the opening degree of the fuel supply valve 120 becomes a second opening degree that is less than the first opening degree in a state, in which the fuel-line purge valve FPV is opened, and opening the fuel supply valve 120 such that the opening degree of the fuel supply valve 120 becomes a third opening degree that is more than the second opening degree, (ii-2) an operation of opening the fuel supply valve 120 such that the opening degree of the fuel supply valve 120 becomes a fourth opening degree that is more than the second opening degree in a state, in which the fuel-line purge valve FPV is cut off, and (ii-3) an operation of opening the fuel supply valve 120 such that the opening degree of the fuel supply valve 120 is more than the second opening degree in a state, in which the fuel-line purge valve FPV is opened.

For example, the first opening degree may be a maximum opening degree (for example, an opening degree of 100%), the second opening degree may be an opening degree of 50%, and the third opening degree, the fourth opening degree, and the fifth opening degree may be a maximum opening degree (for example, an opening degree of 100%). However, the values of the first opening degree, the second opening degree, the third opening degree, the fourth opening degree, and the fifth opening degree are simple examples for helping understanding, and the present disclosure is not limited to the examples.

Then, the controller 200 may open the fuel supply valve 120 such that the opening degree of the fuel supply valve 120 becomes the fifth opening degree that is more than the second opening degree in a state, in which the fuel-line purge valve FPV is opened, and may perform a control such that the opening degree of the fuel supply valve 120 is maintained at the fifth opening degree for a preset time period.

As an example, the controller 200 may open the fuel supply valve 120 such that the opening degree of the fuel supply valve 120 becomes the fifth opening degree (for example, 100%) that is more than the second opening degree (for example, 50%) in a state, in which the fuel-line purge valve FPV is opened (for example, an opening degree of 100%), and the time period, for which the fifth opening degree is maintained, may be set to 3 seconds.

Meanwhile, the controller 200 may perform a control such that the pressure of the hydrogen on the hydrogen supply line 11 is not changed excessively rapidly to effectively flush the fuel cell. As an example, the controller 200 may perform the second operation such that an absolute value of a change per unit time of the pressure (for example, the target hydrogen pressure) of the hydrogen on the hydrogen supply line 11 satisfies a condition of less than a first threshold value. For example, the first threshold value may be 1 bar/sec.

Furthermore, to flush the air electrode of the fuel cell stack 10, the controller 200 may perform the first operation of adjusting the pressure of the hydrogen on the hydrogen supply line 11 to the threshold pressure or more by opening the fuel supply valve 120 in a state, in which the fuel-line purge valve FPV is cut off, may perform the second operation of controlling the fuel supply valve 120 and the fuel-line purge valve FPV such that the flow velocity of the hydrogen on the hydrogen supply line 11 is changed, and then may perform the third operation of controlling the air compressor 140 such that the air is supplied to the fuel cell stack 10.

Then, the controller 200 may stop an operation of the air compressor 140 while the hydrogen electrode is flushed (that is, while the first operation and the second operation are performed) to prevent the pressure of the hydrogen in the hydrogen supply line 11 from being changed due to the operation of the air compressor 140.

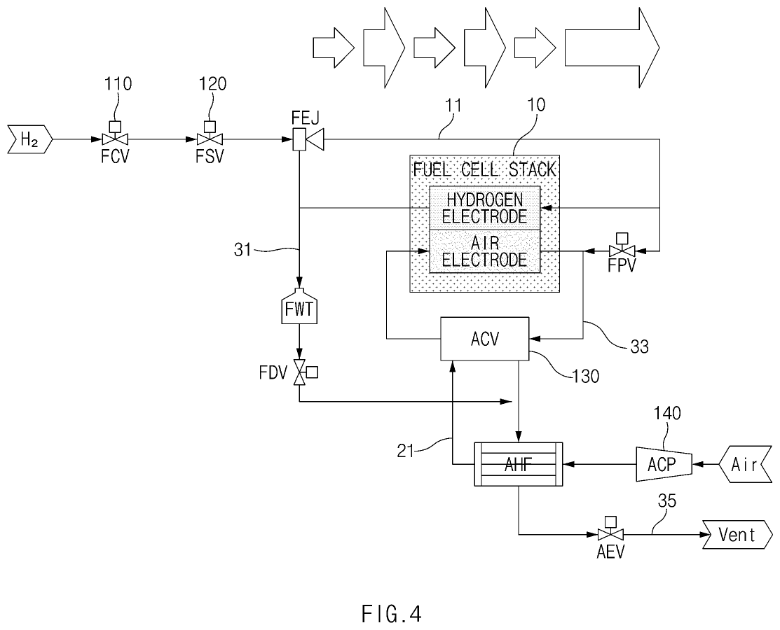

FIG. 4 is a graph schematically illustrating a result of performances of the first operation, the second operation, and the third operation by the controller 200.

First, referring to a first section of FIG. 4, it may be identified that an opened state of the fuel supply valve 120 is maintained for 5 seconds such that the opening degree of the fuel supply valve 120 becomes the first opening degree (for example, an opening degree when 2 bar that is a maximum hydrogen pressure is set as the target hydrogen pressure) in a state, in which the fuel-line purge valve FPV is closed. As described above, it may be identified that the actual hydrogen pressure follows the target hydrogen pressure well because the fuel-line purge valve FPV is cut off.

Furthermore, referring to a (2_1)-th section, it may be identified that, after an operation of opening the fuel supply valve 120 such that the opening degree of the fuel supply valve 120 becomes the second opening degree (for example, an opening degree when 1 bar that is a minimum hydrogen pressure is set as the target hydrogen pressure), which is less than the first opening degree, in a state, in which the fuel-line purge valve FPV is opened, was performed once, an operation of opening the fuel supply valve 120 such that the opening degree of the fuel supply valve 120 becomes the third opening degree (for example, an opening degree when 2 bar that is a maximum hydrogen pressure is set as the target hydrogen pressure), which is more than the second opening degree, was performed once. Then, it may be identified that the actual hydrogen pressure cannot follow the target hydrogen pressure well because the fuel-line purge valve FPV is opened as illustrated above.

Furthermore, referring to a (2_2)-th section, it may be identified that an operation of opening the fuel supply valve 120 such that the opening degree of the fuel supply valve 120 becomes the fourth opening degree (for example, an opening when 2 bar that is a maximum hydrogen pressure is set as the target hydrogen pressure) that is more than the second opening degree in a state, in which the fuel-line purge valve FPV is cut off, was performed once. Similarly, it may be identified that the actual hydrogen pressure follows the target hydrogen pressure well because the fuel-line purge valve FPV is cut off.

Furthermore, referring to a (2_3)-th section, it may be identified that an operation of opening the fuel supply valve 120 for about 3 seconds such that the opening degree of the fuel supply valve 120 becomes the fifth opening degree (for example, an opening degree when 2 bar that is a maximum hydrogen pressure is set as the target hydrogen pressure) that is more than the second opening degree in a state, in which the fuel-line purge valve FPV is opened, was performed. Then, it may be identified that the actual hydrogen pressure fails to follow the target hydrogen pressure well (that is, the flow velocity of the hydrogen is changed) because the fuel-line purge valve FPV is opened as described above.

Furthermore, referring to a third section (for example, after 20 seconds), it may be identified that driving of the air compressor was started such that the air is supplied to the fuel cell stack.

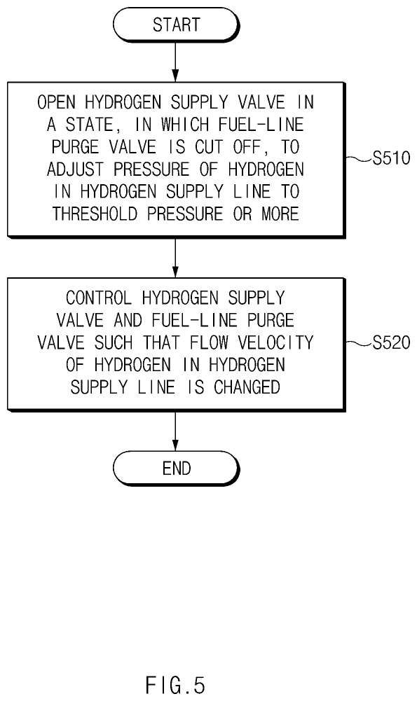

For reference, FIG. 5 schematically illustrates a state, in which the flow velocity of the hydrogen in the hydrogen supply line is changed by performing the process.

Meanwhile, according to an embodiment, the controller 200 may determine whether the fuel cell is abnormal in a process of starting the fuel cell after performing the above process before starting the fuel cell such that the flow velocity of the hydrogen on the hydrogen supply line 11 is changed.

As an example, the controller 200 may determine whether the fuel cell is abnormal with reference to the at least some of the first to n-th unit cell voltages and a reference cell voltage determined with reference to at least some of first to n-th unit cell voltages corresponding to first to n-th unit cells of the fuel cell stack, respectively. For example, the reference cell voltage may correspond to an average value of the first to n-th unit cell voltages.

According to an embodiment, the controller 200 may determine that the fuel cell is abnormal when a specific unit cell corresponding to, among the first to n-th unit cell voltages, a specific unit cell voltage, of which an absolute value of a difference from the reference cell voltage is the second threshold value or more, is present. For example, the controller 200 may compare the first to n-th unit cell voltages with the reference cell voltage, and may determine whether a specific unit cell has a voltage less than the reference cell voltage by 0.2 V or more, and may determine that the fuel cell is abnormal when the specific unit cell is present.

Furthermore, the controller 200 may stop starting the fuel cell when determining that the fuel cell is abnormal.

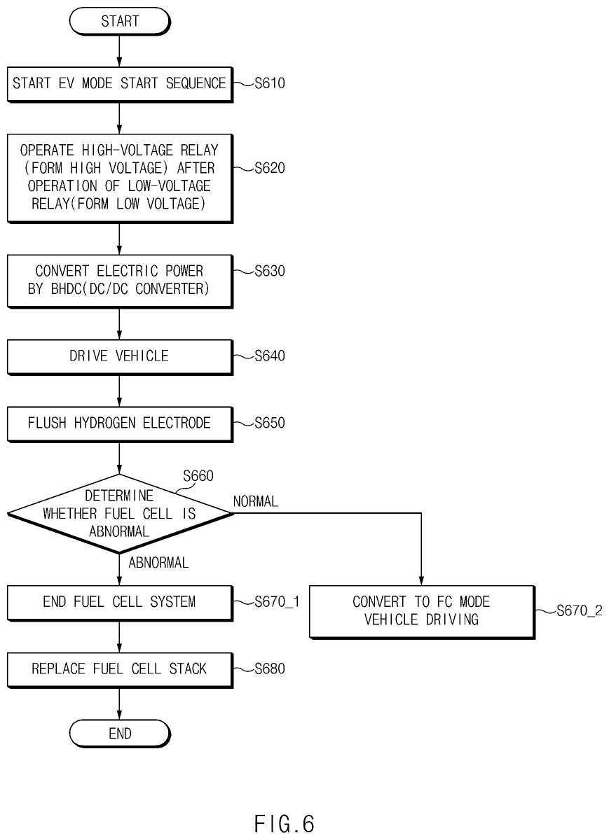

Meanwhile, FIG. 6 is a flowchart of the vehicle driving method using the fuel cell flushing system according to an embodiment disclosed in the present disclosure.

First, as a start button of the vehicle, on which the fuel cell system is mounted, is input, an EV mode start sequence for driving the vehicle with a battery for a vehicle may be started (S610). Furthermore, a high-voltage may be formed through an operation of a high-voltage relay after a low voltage (for example, 12 V) is formed through an operation of a low-voltage relay (S620). Furthermore, after the electric power is converted by a bi-directional high-voltage DC-DC converter (BHDC), the energy stored in the battery for a vehicle may be used to drive the vehicle (S640).

In this way, in a state, in which the vehicle is temporarily driven by using the battery for a vehicle, the above-described electrode flushing process may be performed (S650). Thereafter, it is determined whether the fuel cell is abnormal (S660), and when it is determined that the fuel cell is abnormal, the fuel cell system is immediately ended (S670_1), and repair and replacement of the fuel cell stack may be supported (S680). When it is determined that the fuel cell is normal, the vehicle is converted to FC mode driving whereby the vehicle may be driven by using the fuel cell as an energy source (S670_2).

In this way, the vehicle that uses the fuel cell as an energy source is allowed to be driven while the fuel cell is flushed whereby a problem of driving of the vehicle being restricted due to the flushing (ending of the start of the fuel cell and repetition of restarts) of the conventional fuel cell.

Furthermore, when being compared with the conventional case, in which the hydrogen electrode is flushed by supplying hydrogen at a constant pressure, the hydrogen electrode is flushed while the flow velocity of the hydrogen is changed according to the present disclose whereby a consumption of the hydrogen may be reduced.

The fuel cell flushing system according to the embodiments disclosed in the present disclosure may effectively flush the fuel cell without ending the start of the fuel cell and restarting the fuel cell.

The fuel cell flushing system according to the embodiments disclosed in the present disclosure may remarkably reduce an amount of hydrogen that is consumed to flush the fuel cell.

The present disclosure has been made to solve the above-mentioned problems occurring in the prior art while advantages achieved by the prior art are maintained intact.

Nitrogen may be injected to the hydrogen electrode, a fuel cut-off valve FCV, a fuel supply valve FSV, and the like of the fuel cell for various reasons, and for example, nitrogen may be injected to the fuel cell for inspection of sealing of the fuel cell.

However, after nitrogen is injected into the fuel cell, a process of normally starting the fuel cell causes a problem. For example, when nitrogen is injected for a reason, for example, of inspection sealing of the fuel cell, the hydrogen is insufficiently supplied to the fuel cell stack, and thus voltages of some of unit cells in the fuel cell stack have values that are lower than those of the normal unit cells whereby starting of the fuel cell is ended.

However, conventionally, because a separate process for flushing the nitrogen injected to the fuel cell is not present, a process of repeatedly restarting the fuel cell until hydrogen is sufficiently supplied to the hydrogen electrode of the fuel cell stack once the starting of the fuel cell is ended has to be performed. Furthermore, in this process, a considerable amount of the hydrogen stored in the hydrogen tank is consumed.

Furthermore, according to a safety standard for the fuel cell system, when voltages of the unit cells in the fuel cell stack are abnormal, the start of the fuel cell necessarily has to be ended, and foreign substances (for example, nitrogen) in the fuel cell stack have to be removed before the fuel cell is started again.

However, as described above, conventionally, because the nitrogen injected into the hydrogen electrode of the fuel cell stack may be removed only when a process of repeating restarts is performed, a safety standard (that is, a safety standard telling that foreign substances in the fuel cell stack has to be removed with no restart process) for the fuel cell system cannot be satisfied.

The technical problems to be solved by the present disclosure are not limited to the aforementioned problems, and any other technical problems not mentioned herein will be clearly understood from the following description by those skilled in the art to which the present disclosure pertains.

In addition, various effects directly or indirectly recognized through the present disclosure may be provided.

Although it may have been described until now that all the components constituting the embodiments of the present disclosure are coupled to one or coupled to be operated, the present disclosure is not essentially limited to the embodiments. That is, without departing from the purpose of the present disclosure, all the components may be selectively coupled into one or more components to be operated.

Furthermore, because the terms, such as “comprising”, “including”, or “having” may mean that the corresponding component may be included unless there is a specially contradictory description, it should be construed that another component is not extruded but may be further included. In addition, unless defined otherwise, all terms used herein, including technical or scientific terms, have the same meanings as those generally understood by those skilled in the art to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

The above description is a simple exemplification of the technical spirits of the present disclosure, and the present disclosure may be variously corrected and modified by those skilled in the art to which the present disclosure pertains without departing from the essential features of the present disclosure. Accordingly, the embodiments disclosed in the present disclosure is not provided to limit the technical spirits the embodiments of the present disclosure but provided to describe the present disclosure, and the scope of the technical spirits of the present disclosure is not limited by the embodiments. Accordingly, the genuine technical scope of the present disclosure should be construed by the attached claims, and all the technical spirits within the equivalent ranges fall within the scope of the present disclosure.

What is claimed is:

1. A fuel cell system comprising:
a fuel cell stack;
a plurality of parts including a hydrogen supply line for supplying hydrogen to the fuel cell stack; and
a controller configured to control operations of the plurality of parts to change a flow velocity of hydrogen in the hydrogen supply line.

2. The fuel cell system of claim 1, wherein the plurality of parts further include:
a fuel supply valve configured to control supply of the hydrogen to the fuel cell stack; and
a fuel-line purge valve configured to discharge gas in a hydrogen electrode of the fuel cell stack.

3. The fuel cell system of claim 2, wherein the controller is further configured to:
perform a first operation of opening the fuel supply valve in a state, in which the fuel-line purge valve is cut off, to adjust a pressure of the hydrogen on the hydrogen supply line to a threshold pressure or more; and
perform a second operation of controlling the fuel supply valve and the fuel-line purge valve such that the flow velocity of the hydrogen on the hydrogen supply line is changed.

4. The fuel cell system of claim 3, wherein the controller is further configured to:
perform, (i) as the first operation, an operation of opening the fuel supply valve such that an opening degree of the fuel supply valve becomes a first opening degree in a state, in which the fuel-line purge valve is cut off;
perform, (ii) as the second operation, (ii-1) an operation of opening the fuel supply valve such that the opening degree of the fuel supply valve becomes a second opening degree that is less than the first opening degree in a state, in which the fuel-line purge valve is opened, and then, opening the fuel supply valve such that the opening degree of the fuel supply valve becomes a third opening degree that is more than the second opening degree, (ii-2) an operation of opening the fuel supply valve such that the opening degree of the fuel supply valve becomes a fourth opening degree that is more than the second opening degree in a state, in which the fuel-line purge valve is cut off; and
perform (ii-3) an operation of opening the fuel supply valve such that the opening degree of the fuel supply valve becomes a fifth opening degree that is more than the second opening degree in a state, in which the fuel-line purge valve is opened.

5. The fuel cell system of claim 4, wherein the controller is further configured to:
perform (ii-3) an operation of opening the fuel supply valve such that the opening degree of the fuel supply valve becomes the fifth opening degree that is more than the second opening degree in a state, in which the fuel-line purge valve is opened; and
perform a control such that the opening degree of the fuel supply valve is maintained at the fifth opening degree for a preset time period.

6. The fuel cell system of claim 3, wherein the controller is further configured to perform the second operation such that an absolute value of a change per unit time of the pressure of the hydrogen on the hydrogen supply line satisfies a condition of less than a first threshold value.

7. The fuel cell system of claim 2, wherein the plurality of parts further includes an air compressor configured to supply air to the fuel cell stack.

8. The fuel cell system of claim 7, wherein the controller is further configured to:
perform a first operation of adjusting a pressure of the hydrogen on the hydrogen supply line to a threshold pressure or more by opening the fuel supply valve in a state, in which the fuel-line purge valve is cut off;
perform a second operation of controlling the fuel supply valve and the fuel-line purge valve such that the flow velocity of the hydrogen on the hydrogen supply line is changed; and
perform a third operation of controlling the air compressor such that the air is supplied to the fuel cell stack.

9. The fuel cell system of claim 1, wherein the controller is further configured to:
control operations of the plurality of parts such that the flow velocity of the hydrogen on the hydrogen supply line is changed before starting the fuel cell; and
determine, in a process of starting the fuel cell, whether the fuel cell is abnormal with reference to the at least some of first to n-th unit cell voltages and a reference cell voltage determined with reference to at least some of the first to n-th unit cell voltages corresponding to first to n-th unit cells of the fuel cell stack, respectively.

10. The fuel cell system of claim 9, wherein the controller is further configured to determine that the fuel cell is abnormal when a specific unit cell corresponding to, among the first to n-th unit cell voltages, a specific unit cell voltage, of which an absolute value of a difference from the reference cell voltage is a second threshold value or more, is present.

11. A method of flushing a fuel cell system, the method comprising:
opening a fuel supply valve configured to control supply of hydrogen to a fuel cell stack in a state, in which a fuel-line purge valve configured to discharge gas in a hydrogen electrode of the fuel cell stack is cut off, to adjust a pressure of hydrogen in a hydrogen supply line in which the hydrogen supplied to the fuel cell stack flows, to a threshold pressure or more; and
controlling the fuel supply valve and the fuel-line purge valve to change a flow velocity of the hydrogen on the hydrogen supply line.

12. The method of claim 11, wherein the opening of the fuel supply valve in the state, in which the fuel-line purge valve is cut off, includes:
opening the fuel supply valve such that an opening degree of the fuel supply valve becomes a first opening degree in a state, in which the fuel-line purge valve is cut off.

13. The method of claim 12, wherein the controlling of the fuel supply valve and the fuel-line purge valve such that the flow velocity of the hydrogen on the hydrogen supply line is changed includes:
opening the fuel supply valve such that the opening degree of the fuel supply valve becomes a second opening degree that is less than the first opening degree in a state, in which the fuel-line purge valve is opened, and then, opening the fuel supply valve such that the opening degree of the fuel supply valve becomes a third opening degree that is more than the second opening degree;
opening the fuel supply valve such that the opening degree of the fuel supply valve becomes a fourth opening degree that is more than the second opening degree in a state, in which the fuel-line purge valve is cut off; and
opening the fuel supply valve such that the opening degree of the fuel supply valve becomes a fifth opening degree that is more than the second opening degree in a state, in which the fuel-line purge valve is opened.

14. The method of claim 13, wherein the opening of the fuel supply valve such that the opening degree of the fuel supply valve becomes the fifth opening degree that is more than the second opening degree in a state, in which the fuel-line purge valve is opened includes:
performing a control such that the opening degree of the fuel supply valve is maintained at the fifth opening degree for a preset time period.

15. The method of claim 11, wherein the controlling of the fuel supply valve and the fuel-line purge valve such that the flow velocity of the hydrogen on the hydrogen supply line is changed includes:
controlling the fuel supply valve and the fuel-line purge valve such that an absolute value of a change per unit time of the pressure of the hydrogen on the hydrogen supply line satisfies a condition of less than a first threshold value.

16. The method of claim 11, further comprising:
supplying air to the fuel cell stack by controlling an air compressor configured to supply the air to the fuel cell stack.

17. The method of claim 11, further comprising:
determining a reference cell voltage determined with reference to at least some of first to n-th unit cell voltages corresponding to first to n-th unit cells of the fuel cell stack, respectively; and
determining whether the fuel cell is abnormal with reference to the at least some of the first to n-th unit cell voltages, in a process of starting the fuel cell.

18. The method of claim 17, wherein the determining of whether the fuel cell is abnormal includes:
determining that the fuel cell is abnormal when a specific unit cell corresponding to, among the first to n-th unit cell voltages, a specific unit cell voltage, of which an absolute value of a difference from the reference cell voltage is a second threshold value or more, is present.

19. The fuel cell system of claim 1, wherein the controller is further configured to control flushing of the fuel cell stack by:
gradually increasing pressure in the hydrogen supply line to not exceed preset increments in pressure, to prevent a rapid increase in pressure; or
gradually decreasing pressure in the hydrogen supply line to not fall below preset decrements in pressure, to prevent a rapid decrease in pressure.

20. The fuel cell system of claim 1, wherein the controller is further configured to communicate with the plurality of parts by wire or wirelessly.
